(19) United States
(12) Patent Application Publication
(10) Pub. No.: US 2005/0213927 A1
(43) Pub. Date: Sep. 29, 2005

(54) Topic-oriented Method of recording digital contents broadcast in accordance with a schedule

(75) Inventors: Christian Bertin, Rennes (FR); Sebastien Campion, Rennes (FR); Isabelle Amonou, Thorigne Fouillard (FR)

Correspondence Address: James R. Williams;Jameson, Seltzer, Harper & Williams, 2625 Wilmington Road, New Castle, PA, 16105, US

(73) Assignee: France Telecom, Paris (FR)

(21) Appl. No.: 10/765,447

(22) Filed: Jan. 27, 2004

(30) Foreign Application Priority Data
Jan. 27, 2003 (FR) 0300883

(51) Int. Cl. H04N 5/76

(52) U.S. Cl. 386/46; 386/125

(57) ABSTRACT

The method of recording audiovisual contents broadcast according to a schedule includes: a step of selecting from an access terminal an audiovisual content to be recorded, the content being associated with a broadcast date and time, and a step of the access terminal receiving a record file of the selected audiovisual content, said file containing information identifying the audiovisual content and the scheduled date and time for broadcasting it. The record file further includes the address of an update server for generating a request to update the record file sent by the terminal to the update server.

The present invention relates to a method of recording audiovisual contents broadcast according to a schedule, and to a system, a presentation server, and an access terminal, all for implementing the method.

### FIELD OF THE INVENTION

The term “broadcasting” is used generally to mean broadcasting audiovisual contents on any type of medium, such as satellite, cable, terrestrial radio transmission or the Internet.

To be more precise, the invention relates to a method comprising the steps of:
selecting from an access terminal an audiovisual content to be recorded, the content being associated with a broadcast date and time, and
the access terminal receiving a record file of the selected audiovisual content, said file containing information identifying the audiovisual content and the scheduled date and time for broadcasting it.

### BACKGROUND OF THE INVENTION

Methods of the above kind are known in the art.

For example, it is possible to consult a program guide on a website from an access terminal connected to the Internet. The site generally facilitates searching and in due course, subject to a little browsing and filling in search criteria, shows all available information on audiovisual contents of interest to the user, including information identifying the contents and the scheduled date and time for broadcasting them. This information may then be downloaded into the access terminal.

There is also provision for broadcasting audiovisual contents with associated descriptive data. The Digital Video Broadcasting (DVB) forum has drawn up the Digital Video Broadcasting—Service Information (DVB-SI) standard for broadcasting information on broadcast contents. However, the information is usually very limited (channel identifier, broadcast identifier, broadcast title, start time, end time, parental control, etc.).

Finally, the specifications of the TV Anytime forum propose a solution for automatic recording of audiovisual contents with associated descriptive data appropriate to the content. However, the solution proposed by TV Anytime is complex and requires processing power that is too high for most current access terminals. Among other things, it requires the terminals to be able to translate and process files whose format is imposed by TV Anytime. This format becomes difficult to manage for a consumer terminal, e.g. if the terminal seeks to obtain, from a server, an update of the record file that it has received.

### OBJECTS AND SUMMARY OF THE INVENTION

The invention aims to eliminate the above drawbacks by providing a method of recording audiovisual contents broadcast according to a schedule that is capable of processing modifications to the date and/or time of the broadcast, or even cancellation of the broadcast; and that constitutes a relatively simple solution requiring the access terminal to have only moderate processing capacity.

To this end, the invention consists in a method of the above-specified type, characterized in that the record file further includes the address of an update server for generating a request to update the record file sent by the terminal to the update server.

A method of the invention thus makes it possible, solely by means of information contained in the record file, to generate a simple request to an update server, which has sufficient processing capacity to interpret the request, advise on a new date and/or time of a broadcast, or on a cancellation of the broadcast, and, if necessary, send update information to the access terminal.

A method conforming to the invention may further comprise one or more of the following features:
it includes a step of updating the record file in the event of modification of the date and/or time of the broadcast, or cancellation of broadcasting a selected audiovisual content, or substitution of some other audiovisual content;
the update request includes the address of the update server and the identification information of the audiovisual content;
the request is an HTTP request;
the terminal sends the request to update the record file periodically up to the date and time scheduled for broadcasting the selected audiovisual content;
during the selection step, a single audiovisual content is selected, and the terminal sends the request to update the record file increasingly often as the date and time for recording the selected audiovisual content approaches;
the record file includes a field marked by a markup and defining the address of the update server;
the record file includes at least one field marked by a markup and defining information identifying the corresponding audiovisual content associated with data describing said content;
the record file includes one field marked by a markup and defining, for a given audiovisual content in the same file, a content identifier associated with a content already recorded in the storage means of the access terminal;
the syntax of files exchanged between the access terminal and the server is defined by an unique data structure schema, in particular an XML schema;
the method includes a preliminary step of selecting a plurality of contents having a common topic, and a step of receiving a record request file from which the access terminal generates a record-request request designed to be sent to a predetermined server for executing automatically the selection step;
the record request file includes the address of said predetermined server for generating the record-request request; and
the request includes the reference of a user for statistical purposes.

The invention further consists in a system for recording audiovisual contents broadcast in accordance with a schedule and adapted to execute a method as described above, the system being characterized in that it includes at least one access terminal comprising means for selecting an audiovisual content to be recorded associated with a broadcast date and time, said access terminal including means for receiving a record file of the selected audiovisual content, said file containing information identifying the audiovisual content and the scheduled date and time for broadcasting it, and in that the record file further includes the address of an update server for generating a request to update the record file sent by the terminal to the update server.

The invention further consists in an update server adapted to execute a method as described above and characterized in that it includes means for updating the record file.

Finally, the invention also provides an access terminal adapted to execute a method as defined above, and characterized in that it includes means for selecting an audiovisual content to be recorded associated with a broadcast date and time, means for receiving a record file of the selected audiovisual content, said file containing information identifying the audiovisual content and the scheduled date and time for broadcasting it, and further including the address of an update server for generating a request to update the record file sent by the terminal to the update server.

### BRIEF DESCRIPTION OF THE DRAWINGS

The invention will be better understood after reading the following description, which is given by way of example only and with reference to the appended drawings, in which:

FIG. 1 is a diagram showing the general structure of a recording system of the invention;

FIG. 2 represents a page presenting audiovisual contents that are broadcast in accordance with a schedule and may be recorded using a first embodiment of the invention;

FIG. 3 shows the successive steps of a first embodiment of a recording method of the invention;

FIG. 4 represents a page presenting audiovisual contents that are broadcast in accordance with a schedule and may be recorded using a second embodiment of the invention; and

FIG. 5 shows the successive steps of a second embodiment of a recording method of the invention.

### MORE DETAILED DESCRIPTION

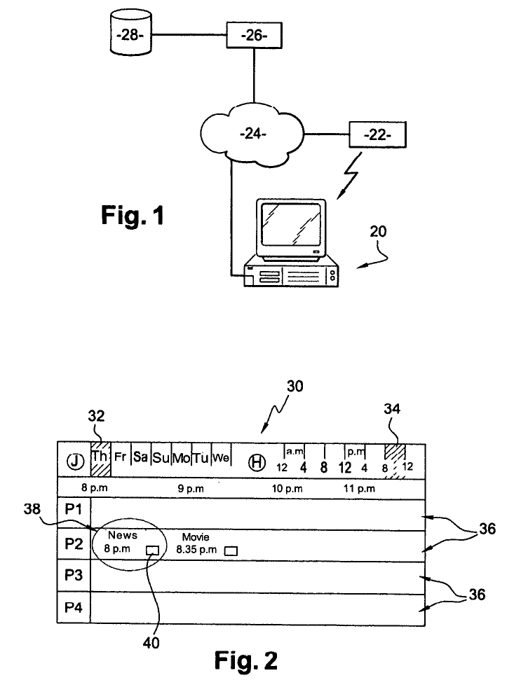

The system shown in FIG. 1 includes a terminal 20 that is used to access audiovisual contents broadcast by a program broadcaster 22.

The access terminal 20 and the broadcaster 22 are both connected to an information transmission network 24, such as the Internet, for example, enabling them to exchange information with an audiovisual content presentation server 26. The terminal 20 incorporates means for recording audiovisual contents, in particular broadcast contents.

The presentation server 26 offers users of the Internet 24 pages presenting audiovisual contents to be broadcast by the broadcaster 22. Information describing the audiovisual contents is held in a database 28 which is connected to the presentation server 26 and is regularly updated by the broadcaster 22 via the presentation server 26, for example if an audiovisual content is removed from the schedule or a scheduled date and time are modified.

The presentation page 30 shown in FIG. 2 is managed by the server 26 and may be consulted by a user of the access terminal 20 via the Internet 24.

The presentation page 30 includes the audiovisual contents to be broadcast in accordance with a schedule, presented on the screen as a function of a day 32 and a selected time slot 34. On this presentation page, several lines 36 correspond to several broadcasting channels P1, P2, P3, and P4, each associated with a succession of audiovisual contents that are broadcast in accordance with a schedule at predetermined times. For example, a newscast 38 is broadcast every Thursday between 8.00 pm and 8.35 pm by channel P2.

Each of the audiovisual contents that are broadcast in accordance with a schedule are associated with an icon 40 enabling the user of the access terminal 20 to select said audiovisual content in order to record it in the storage means of the access terminal 20.

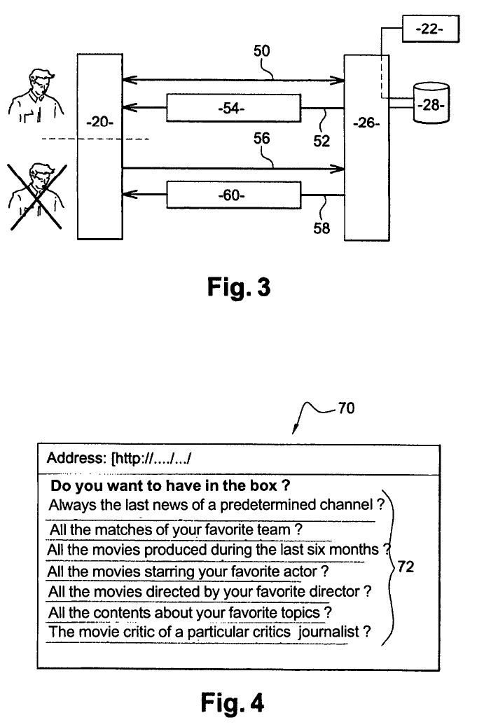

The record process shown in FIG. 3 includes a first step 50 during which the user interacts with the presentation page 30 and clicks on one or more icons to select one or more audiovisual contents that are broadcast in accordance with a schedule.

After the above step, the presentation server 26 recovers from the database 28 the information associated with the selected audiovisual contents.

In a step 52, the server supplies the information to the access terminal 20 in the form of a record file 54.

The record file 54 may have the following structure, using the XML syntax:

<Record>

<UpdateServerAddress>

http:\\www.TVPortal.com\adrf3j2.FRG?

</UpdateServerAddress>
<RecordElement>

<ContentId>

Content n°1

</ContentId>
<TVAMain>

...
<ProgramInformation Table>

...

</ProgramInformation Table>
<ServiceInformation Table>

...

</ServiceInformation Table>
<ProgramLocation Table>

<BroadcastEvent>

...
serviceIDRef=“34567”
fragmentId=“123”
fragmentVersion=“121214”
...

</BroadcastEvent>

</ProgramLocation Table>
...

</TVAMain>

</RecordElement>
<RecordElement>

<TVAMain>

...

</TVAMain>

</RecordElement>

</Record>

The record file includes a start of file “Record” markup (<Record>) and an end of file “Record” marker (</Record>). Between these two markups, it includes data marked out by start and end markups, as per the XML format.

Of the above data, the universal address of an update server, marked by a “UpdateServerAddress” markup, is supplied by the record file to enable the access terminal thereafter to send requests for updating in the event of modification of the date and/or time of the broadcast, cancellation of broadcasting an audiovisual content whose description data is in the record file, or substitution of some other audiovisual content for an audiovisual content in the record file. In this example, the address is that of the presentation server 26, which also has the function of updating record files.

The record file 54 further contains data relating to one or more audiovisual contents selected in the step 50. The data for each audiovisual content is marked by a “RecordElement” markup. In the above example, the record file contains two selected audiovisual contents. It therefore contains two fields marked by the “RecordElement” markup. More generally, it may contain any number thereof.

If the user opts to record this audiovisual content instead of another previously recorded audiovisual content in the storage means of the access terminal 20 and identified by the same content identifier, the data corresponding to a selected audiovisual content may optionally include a content identifier marked by a “ContentId” markup.

Finally, the data corresponding to an audiovisual content generally includes an XML table marked by a “TVAMain” markup and conforming to the specifications of the TV Anytime forum. This table includes a ProgramInformation sub-table for the description of the content, a ServiceInformation sub-table for the description of the service carrying the content, and a ProgramLocation sub-table for the location (time and place) of the content necessary for recording it.

The ProgramLocation sub-table contains, in a “BroadcastEvent” field, an identifier “ServiceIdRef” of the service carrying the content, an identifier “fragmented” of the content, and an identifier “fragmentVersion” of the version of the information associated with the content.

The record file may optionally further contain a user reference. If so, the reference is marked by a corresponding markup.

Then, in a step 56, the terminal 20 generates a request to update the record file on the basis of the information contained in the file. The request contains the address of the server 26 associated with the identifier “fragmented” and with the identifier “fragmentVersion”. It may take the following concatenated form in the event of a HTTP request:

http://www.TVPortal.comadrl3j2.FRG?fragmentld=123&fragmentVersion=121214

Where appropriate, for statistical purposes, the request optionally further contains the reference of the user.

As soon as the request is received, the presentation and update server 26 verifies the information relating to the content corresponding to fragmentId=123 stored in the database 28 and its version identifier.

Then, during a final step 58, the server sends a response to the update request. The response contains an update file 60.

The update file 60 may have the following structure, using the XML syntax:

<UPDATE_ANSWER type= TYPE>

<TVAMain>

...
<ServiceInformation Table>

...

</ServiceInformation Table>
<ProgramLocation Table>

<BroadcastEvent>

...
serviceIDRef=“34567”
fragmentId=“123”
fragmentVersion=“121215”
...

</BroadcastEvent>

</ProgramLocation Table>
...

</TVAMain>

</UPDATE_ANSWER>

If the version identifier of the data from the database matches the version identifier of the request, the information associated with the audiovisual content to be recorded has not changed. In this case, the update file 60 is identified by the value TYPE=“Unmodified”, indicating that the broadcasting of the corresponding content has not been modified.

If the version identifier of the data from the database has a value higher than the version identifier of the request, the information associated with the audiovisual content has been updated since the record file 54 was transmitted. In this case, the update file 60 is identified by the value TYPE=“New-version”, indicating that the descriptive data for the corresponding content has been modified.

As soon as this file is received, the access terminal replaces the corresponding table “TVAMain” in the record file 54. In particular, if the broadcaster 22 has modified the date and/or the time of recording, this update enables the access terminal to take account of this fact for starting a recording.

If the server 26 has replaced the selected content with some other audiovisual content, the update file 60 is identified by the value TYPE=“New-content”, indicating that the audiovisual content to be recorded has been modified. In this case, as in the above case, the corresponding table “TVAMain” is replaced in the record file 54.

If the server 26 has cancelled the selected content, the update file 60 is identified by the value TYPE=“Cancelled”, indicating that the audiovisual content to be recorded has been cancelled. In this case, recording is cancelled.

Finally, if the server does not find the selected content in the database 28, the update file 60 is identified by the value TYPE=“Unknown”, indicating that the audiovisual content to be recorded has not been found. In this case, recording is cancelled.

Steps 56 and 58 are repeated several times, for example regularly every four hours, up to the time of recording the individual content(s) concerned.

An alternative is to repeat steps 56 and 58 several times, and more and more often as the date and time for recording the selected audiovisual content approaches. This option is suitable for the situation in which only one audiovisual content has been selected, of course.

The presentation page 70 shown in FIG. 4 is managed by the server 26 and may be consulted by a user of the access terminal 20 via the Internet 24. This represents a second embodiment of the invention.

The presentation page 70 includes a list 72 of record commands, each for recording a set of contents having a common topic. For example, such commands denote “always the latest newscast on a particular channel”, “all matches of your favorite team”, “all films released in the past six months”, “all films with your favorite actor”, “all films of your favorite director”, “all contents on your favorite subject”, “film reviews by a particular critic”.

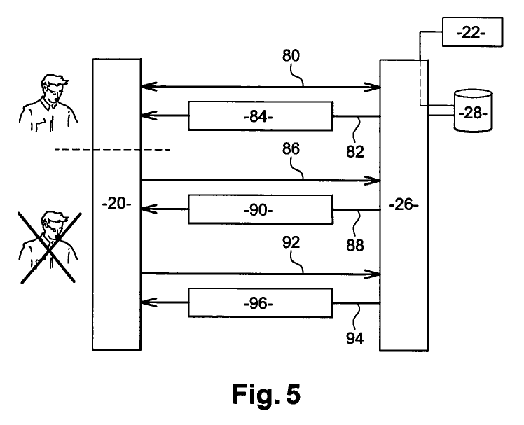

The record request process shown in FIG. 5 includes a first step 80 during which the user interacts with the presentation page 70 and clicks on one of the record commands from the list 72.

Following this step, the presentation server 26 recovers information stored in the database 28 and associated with audiovisual contents whose topic corresponds to the selected record command.

Then, in a step 52, the server supplies the information to the access terminal 20 in the form of a record request file 84.

The record request film 84 may have the following structure, employing the XML syntax:

<RecordRequest>

<RecordRequestServerAddress>

http:\\www.TVPortal.com\adrf3j2.REC

</RecordRequestServerAddress>
<Periodicity>

04:00:00

</Periodicity>

</RecordRequest>

The record request file 84 includes a start of file “RecordRequest” markup (<RecordRequest>) and an end of file “RecordRequest” markup (</RecordRequest>). Between these two markups, it comprises data marked out by start and end markups, as per the XML standard.

Of the above data, the universal address (URL) of an update server, marked by a “RecordRequestServerAddress” marker, is supplied by the record request file to enable the access terminal 20 thereafter to send requests to update the record request file. In this example, as in the above example, the address is that of the presentation server 26, which also has the function of updating record request files.

The record request file 84 may optionally further comprise periodicity information to indicate to the access terminal 20 a period for sending update requests and marked by a “Periodicity” markup. In this example, the presentation server 26 requests to be contacted every 4 hours.

Then, in a step 86 that is repeated automatically at periods indicated by the “Periodicity” field, the terminal 20 sends a request to the presentation server 26 whose address is listed in the record request file 84. The address includes an indication enabling the presentation server 26 to determine the record command selected by the user.

The request may take either of the following two forms:

http:\\www.TVPortal.com\adrf3j2.REC

or

http:www.TVPortal.comadrf3j2. REC?MaxRecNb=2.

As indicated in the above examples, the update request may optionally include a variable “MaxRecNb” that specifies the number of successive audiovisual contents corresponding to the chosen topic which the access terminal 20 must record. In the first of the above requests, if this variable is not appended to the request, the record request is a request to record the first audiovisual content corresponding to the selected topic. In the second request, the variable “MaxRecNb” is equal to 2, which means that the record request relates to the recording of two successive audiovisual contents corresponding to the chosen topic.

In response, the access terminal 20 receives, in a step 88, a record file 90, similar to the record file 54, containing the audiovisual contents corresponding to the topic-oriented record request sent by the user.

If the step 86 is repeated periodically, during the next step 88 the response sent by the presentation server 26 is an update file as described above during step 58.

As above, the update file may be of the “New_version”, “Unmodified”, “New_content”, “Cancelled”, or “Unknown” type, depending on the case.

If the broadcaster 22 modifies the scheduled date and/or time for audiovisual contents, which leads to modifying the database 28, the repeated sending of requests during the step 86 enables updating of the record file 90. In particular, this allows modification of the audiovisual contents to be recorded should a new audiovisual content be scheduled before the next audiovisual content on the selected topic to be recorded.

The following steps 92 and 94, and the update file 96 are similar to steps 56 and 58 and to the update file 60. For this reason, the steps and the file are not described in further detail.

In the examples given in FIG. 4, if the user selects the recording command corresponding to “always the latest newscast on a particular channel”, the record request file 84 may take the following form:

<RecordRequest>

<RecordRequestServerAddress>

http:\\www.TVPortal.com\lastNewsOfBBC.REC

</RecordRequestServerAddress>
<Periodicity>

04:00:00

</Periodicity>

</RecordRequest>

This record request file contains the address of the server 26 and specifies as the topic the latest BBC newscast. The period for updating a corresponding record file is four hours. The access terminal 20 then consults the presentation server:

http:\\www.TVPortal.com\lastNewsOfBBC.REC,

and the server sends it the following file 90:
<Record>

<UpdateServerAddress>

http:\\www.TVPortal.com\lastNewsOfBBC.REC

</UpdateServerAddress>
<RecordElement>

<ContentId>

Content No. 1

</ContentId>
<TVAMain>

<ProgramDescription>

<ProgramInformationTable version=“2”>

<ProgramInformation>

programId=“Crid://www.bbc.co.uk/News19122002”
<BasicDescription>

<Title>

BBC News

</Title>
<Synopsis>

News of the day

</Synopsis>
<Genre href=“:x:x”>

</mpeg7:Name>

</Genre>

</BasicDescription>

</ProgramInformation>

</ProgramInformationTable>

<ProgramLocationTable version=“2”>

<Schedule>

<Event>

<Program

{crid=”crid://www.bbc.co.uk/News19122002-20H00”/>}

<EventDescription>

<PublishedTime>

2002-12-19T20:00:00-00:00

</PublishedTime>
<PublishedDuration>

P0Y0M0DT0H45M

</PublishedDuration>

</EventDescription>

</Event>

<ServiceId Id=“123”/>

</Schedule>

</ProgramLocationTable>
<ServiceInformationTable>

<ServiceInformation serviceId=“123”>

<Name>BBC News</Name>
<Owner>BBC</Owner>

</ServiceInformation>

</ServiceInformationTable>

</ProgramDescription>

</TVAMain>

</RecordElement>

</Record>

As soon as this record file 90 is received, the access terminal is automatically configured to record the audiovisual content(s) corresponding to the dates and times indicated in the file.

After four hours, the terminal sends the above-mentioned update request whether it has already recorded a newscast or not. If a new version of the record file is sent by the server, it reschedules a recording. Steps 56 and 58 are then repeated again.

If, as is possible for the FIG. 4 examples, the user selects the record command “all matches of your favorite team”, the presentation server sends the following record request file, for example:

<RecordRequest>

<RecordRequestServerAddress>

http://www.TVPortal.com\AllManchesterFootballMatch.REC

</RecordRequestServerAddress>
<Periodicity>

24:00:00

</Periodicity>

</RecordRequest>

This record request file contains the address of the server 26 and specifies as the topic matches played by Manchester, if that team is the user's favorite team. The updating period for a corresponding record file is twenty-four hours.

This record file may take the following form:

<Record>

<UpdateServerAddress>

http:\\www.TVPortal.com\AllManchesterFootballMatch.REC

</UpdateServerAddress>
<RecordElement>

<TVAMain>

<ProgramDescription>

<ProgramInformationTable version=“2”>

<ProgramInformation programId=

“crid://www.bbc.co.uk/ManchesterVsLiverpool

2002-back”>

<BasicDescription>

<Title>

Manchester vs Liverpool
England Championship - 2002 - back match

</Title>
<Synopsis>

After the first match between Liverpool &
Manchester, where Liverpool win 1-0 the
Manchester football club should win to
make the final

</Synopsis>
<Genre href=“:x:x”>

<mpeg7:Name>Sport/football</mpeg7:Name>

</Genre>

</BasicDescription>

</ProgramInformation>

</ProgramInformationTable>

<ProgramLocationTable version=“2”>

<Schedule>

<Event>

<Program crid=

“crid://www.bbc.co.uk/ManchesterVs
Liverpool2002-back”/>

<EventDescription>

<PublishedTime>

2002-12-19T21:00:00-00:00

</PublishedTime>
<PublishedDuration>

P0Y0M0DT0H100M

</PublishedDuration>

</EventDescription>

</Event>

<ServiceId Id=“123”/>

</Schedule>

</ProgramLocationTable>
<ServiceInformationTable>

<ServiceInformation serviceId=“123”>

<Name>BBC Sport</Name>
<Owner>BBC</Owner>

</ServiceInformation>

</ServiceInformationTable>

</ProgramDescription>

</TVAMain>

</RecordElement>

</Record>

As soon as this record file 90 is received, the access terminal is automatically configured to record the audiovisual content(s) corresponding to the dates and times indicated in the file.

After twenty-four hours, whether the terminal has already recorded a match or not, it sends the above-mentioned update request. If the server sends a new version of the record file, it reschedules recording. Steps 56 and 58 are therefore repeated again.

If, as is possible in the case of the FIG. 4 examples, the user selects one of the record commands “always the latest newscast on a particular channel”, “all matches of your favorite team”, “all films released in the past six months”, “all films with your favorite actor”, “all films of your favorite director”, “all contents on your favorite subject”, or “film reviews by a particular critic”, the files returned by the server are similar to those for the two situations referred to above.

There follows a precise example of the XML schema structuring the syntax of the record file 54 or 90:

<?xml version=“1.0” encoding=“UTF-8”?>
<xs:schema xmlns:tva=“http://www.tv-anytime.org/2001/08/
metadata”
xmlns:mpeg7=“urn:mpeg:mpeg7:schema:2001”
xmlns:xs=“http://www.w3.org/2001/XMLSchema”
elementFormDefault=“qualified”
attributeFormDefault=“unqualified”>

<1--<import namespace=“http://www.tv-

anytime.org/2001/08/metadata”
schemaLocation=“./tva_metadata_v11.xsd”/>-->

<xs:elementname=“Record” type=“RecordType”>

<xs:annotation>

<xs:documentation xml:lang=“fr”>

This element is the root of the file xx.REC

</xs:documentation>

</xs:annotation>

</xs:element>
<xs:complexType name=“RecordType”>

<xs:sequence>

<xs:element name=“UpdateServerAddress” type=

“xs:anyType”>

<xs:annotation>

<xs:documentation xml:lang=“fr”>

This marker contains the universal
address that the terminal will use to
look up any changes that may have
taken place for the transmissions
scheduled for recording

</xs:documentation>

</xs:annotation>

</xs:element>
<xs:sequence maxOccurs=“unbounded”>

<xs:element name= “RecordElement”>

<xs:annotation>

<xs:documentation xml:lang=“fr”>

This element represents a record
of the user, it contains a TVAMain
node. This TVA node must contain
the minimum for making a
recording, i.e. a
ProgramInformationTable, a
ServiceInformationTable, and a
ProgramLocationTable

</xs:documentation

</xs:annotation>
<xs:complexType>

<xs:sequence>

<xs:element ref=“tva:TVAMain“/>

<xs:element name= “ContentId” minOccurs=“0”>

<xs:annotation>

<xs:documentation xml:lang=“fr”>

This element, if present,
indicates to the terminal
that the content must
replace a content already
present on his disc and
having the same identifier

</xs:documentation>

</xs:annotation>

</xs:element>

</xs:sequence>

</xs:complexType>

</xs:element>

</xs:sequence>

</xs:sequence>

</xs:complexType>

</xs:schema>

There follows a precise example of the XML schema

structuring the syntax of the record request file 84:
<?xml version=“1.0” encoding=“UTF-8”?>
<xs:schema xmins:xs=“http://www.w3-org/2001/XMLSchema”
elementFormDefault=“qualified” attributeFormDefault=“unqualified”>

<xs:elementname=“RecordRequest” type=“RecordRequestType”>

<xs:annotation>

<xs:documentation>Document root element

</xs:documentation>

</xs:annotation>

</xs:element>
<xs:complexType name=“RecordRequestType”>

<xs:sequence>

<xs:element name=“RecordRequestServerAddress”

type= “xs:anyURI”>

<xs:annotation>

<xs:documentation>

This element contains the universal
address to which the terminal must
log on to obtain an update of the
programming information

</xs:documentation>

</xs:annotation>

</xs:element>
<xs:element name=“Periodicity”

type=“xs:duration” minOccurs=“0”>

<xs:annotation>

<xs:documentation>

This element contains the period to
which the terminal must refer for
effecting its updates

</xs:documentation>

</xs:annotation>

</xs:element>

</xs:sequence>

</xs:complexType>

</xs:schema>

1. A method of recording audiovisual contents broadcast according to a schedule, the method including:
a step of selecting from an access terminal an audiovisual content to be recorded, the content being associated with a broadcast date and time, and
a step of the access terminal receiving a record file of the selected audiovisual content, said file containing information identifying the audiovisual content and the scheduled date and time for broadcasting it,
and wherein the record file further includes the address of an update server for generating a request to update the record file sent by the terminal to the update server.

2. A method according to claim 1 of recording audiovisual contents broadcast according to a schedule, the method including a step of updating the record file in the event of modification of the date and/or time of the broadcast, or cancellation of broadcasting a selected audiovisual content, or substitution of some other audiovisual content.

3. A method according to claim 1 of recording audiovisual contents broadcast according to a schedule, wherein the update request includes the address of the update server and the identification information of the audiovisual content.

4. A method according to claim 1 of recording audiovisual contents broadcast according to a schedule, wherein the request is an HTTP request.

5. A method according to claim 1 of recording audiovisual contents broadcast according to a schedule, wherein the terminal sends the request to update the record file periodically up to the date and time scheduled for broadcasting the selected audiovisual content.

6. A method according to claim 1 of recording audiovisual contents broadcast according to a schedule, wherein, during the selection step a single audiovisual content is selected, and wherein the terminal sends the request to update the record file increasingly often as the date and time for recording the selected audiovisual content approaches.

7. A method according to claim 1 of recording audiovisual contents broadcast according to a schedule, wherein the record file includes a field marked by a markup and defining the address of the update server.

8. A method according to claim 1 of recording audiovisual contents broadcast according to a schedule, wherein the record file includes at least one field marked by a markup and defining information identifying the corresponding audiovisual content associated with data describing said content.

9. A method according to claim 1 of recording audiovisual contents broadcast according to a schedule, wherein the record file includes one field marked by a markup and defining, for a given audiovisual content in the same file, a content identifier associated with a content already recorded in the storage means of the access terminal.

10. A method according to claim 1 of recording audiovisual contents broadcast according to a schedule, wherein the syntax of files exchanged between the access terminal and the server is defined by an unique data structure schema, in particular an XML schema.

11. A method according to claim 1 of recording audiovisual contents broadcast according to a schedule, the method including a preliminary step of selecting a plurality of contents having a common topic, and a step of receiving a record request file from which the access terminal generates a record-request request designed to be sent to a predetermined server for executing automatically the selection step.

12. A method according to claim 11 of recording audiovisual contents broadcast according to a schedule, wherein the record request file includes the address of said predetermined server for generating the record-request request.

13. A method according to claim 1 of recording audiovisual contents broadcast according to a schedule, wherein the request includes the reference of a user for statistical purposes.

14. A system for recording audiovisual contents broadcast in accordance with a schedule and adapted to execute a method according to claim 1, the system including at least one access terminal comprising means for selecting an audiovisual content to be recorded associated with a broadcast date and time, said access terminal including means for receiving a record file of the selected audiovisual content, said file containing information identifying the audiovisual content and the scheduled date and time for broadcasting it, and wherein the record file further includes the address of an update server for generating a request to update the record file sent by the terminal to the update server.

15. An update server adapted to execute a method according to claim 1 and including means for updating the record file.

16. An access terminal adapted to execute a method according to claim 1 and including means for selecting an audiovisual content to be recorded associated with a broadcast date and time, means for receiving a record file of the selected audiovisual content, said file containing information identifying the audiovisual content and the scheduled date and time for broadcasting it, and further including the address of an update server for generating a request to update the record file sent by the terminal to the update server.
